(19) United States
(12) Patent Application Publication
(10) Pub. No.: US 2007/0058193 A1
(43) Pub. Date: Mar. 15, 2007

(54) System and method for detecting and releasing selected document processing jobs

(75) Inventor: Vincent Wu, Irvine, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/227,507

(22) Filed: Sep. 15, 2005

(51) Int. Cl. G06F 3/12

(52) U.S. Cl. 358/1.15

(57) ABSTRACT

The present invention is directed to a method and system for detecting at least one selected document processing job at least one document processing device on a network. Data representing at least one selected property associated with at least one document processing job is first received. A query is then sent to each document processing device on the network to determine whether any document processing jobs received by the document processing device have the at least one selected property. The method also includes the steps of detecting, in response to the query, for each document processing device on the network, all document processing jobs having the at least one selected property and selectively communicating the detected document processing jobs for each document processing device so as to be available to an associated user.

### BACKGROUND OF THE INVENTION

This invention is directed to a system and method for detecting selected document processing jobs on document processing devices disposed on a network. More particularly, this invention is directed to a system and method for locating specified document processing jobs on document processing devices on a network, and releasing the specified operations for processing thereof.

In a typical office computer network, multiple document processing devices or multifunctional peripherals are available to the users of the network for document processing operations, such as printing, scanning, or copying. Each of the document processing devices on the network may offer different features or functionalities. For example, one device may provide color document processing capabilities, another device may provide confidential processing capabilities, and still another device may provide monochrome processing capabilities. A user may transmit document processing jobs to a selected device based on the capabilities of the device. However, when the user desires to commence the document processing operation, the user may not remember to which device the document processing device was sent. Currently, in order for a user to determine which document processing jobs were sent to which device, the user must view the pending jobs for each document processing device on the network. This processing is very time consuming and prone to errors. The user may fail to review the pending jobs for a document processing device containing his document processing jobs or may overlook jobs during his review of a particular device. In that instance, those jobs may remain in the queue for the document processing device, occupying storage space, until the job is deleted either by a system administrator or due to the expiration of a set time period for processing the job.

It is desirable to have a system and method for detecting or locating document processing jobs on document processing devices on a network such that a user does not have to manually search each device for the user's pending document processing jobs.

### SUMMARY OF THE INVENTION

In accordance with the present invention, there is provided a system and method for detecting document processing jobs on document processing devices on a network.

Further, in accordance with the present invention, there is provided a system and method for detecting document processing jobs on a network such that a user does not have to manually search device for the user's pending document processing jobs.

Still further, in accordance with the present invention, there is provided a method for detecting at least one selected document processing job at least one document processing device on a network. The method comprises the steps of receiving data representative of at least one selected property associated with at least one document processing job and transmitting a query to each document processing device on the network whether any document processing jobs having the at least one selected property have been received by the document processing device for processing. The method also comprises the steps of detecting, in response to the query, for each document processing device on the network, all document processing jobs having the at least one selected property and selectively communicating the detected document processing jobs for each document processing device so as to be available to an associated user.

Still further, in accordance with the present invention, there is provided a system for detecting at least one selected document processing job at least one document processing device on a network. The system comprised means adapted for receiving data representative of at least one selected property associated with at least one document processing job and means adapted for transmitting a query to each document processing device on the network whether any document processing jobs having the at least one selected property have been received by the document processing device for processing. The system also comprises means adapted for detecting, in response to the query, for each document processing device on the network, all document processing jobs having the at least one selected property and means adapted for selectively communicating the detected document processing jobs for each document processing device so as to be available to an associated user.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flowchart illustrating the clients side of the method according to the present invention; and

FIG. 3 is a flowchart illustrating the document processing device side of the method according to the present invention.

### DETAILED DESCRIPTION OF THE PREFERRED EMBODIMENT

This invention is directed to a system and method for detecting selected document processing jobs on document processing devices disposed on a network. More particularly, this invention is directed to a system and method for locating specified document processing jobs on document processing devices on a network, and releasing the specified operations for processing thereof.

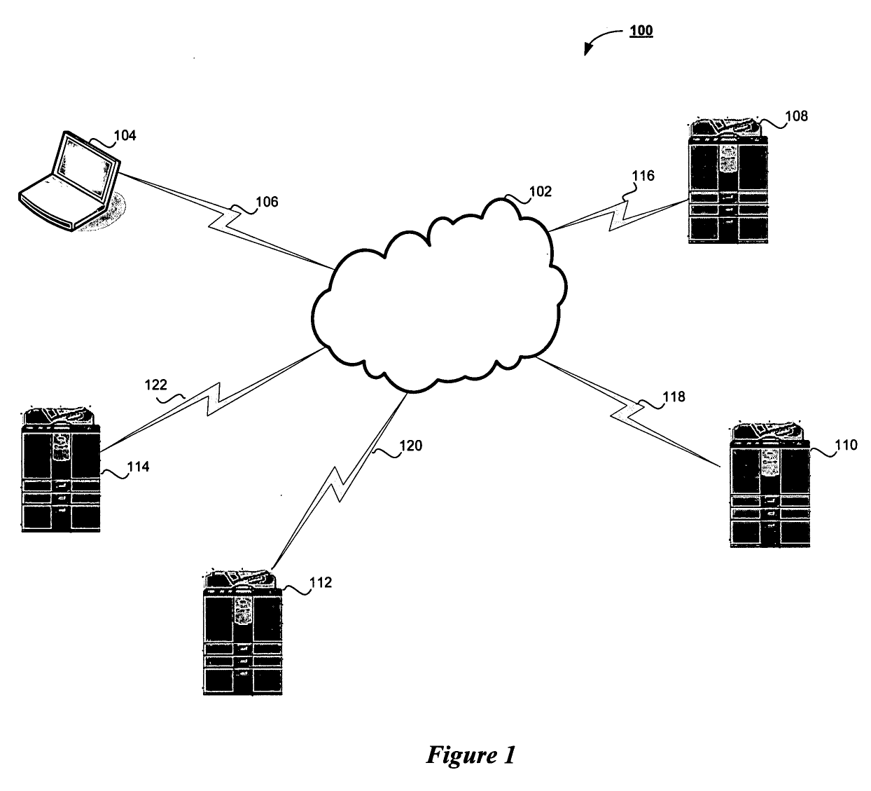

Referring now to FIG. 1, there is shown a system 100 in accordance with the present invention. As shown in FIG. 1, the system 100 includes a computer network 102. It will be understood by those skilled in the art that the computer network 102 is any computer network known in the art and capable of carrying data communications between two or more electronic devices. Suitable computer networks include, but are not limited to intranet, Ethernet-network, Token Ring-network, local area networks, wide area networks, personal area networks, wireless local area network, the Internet, and the like.

The system 100 further includes a user device 104, illustrated in FIG. 1 as a laptop computer. It will be appreciated by those skilled in the art that the use of a laptop computer is for illustration purposes only and the present invention is not so limited. Thus, for example and without limitation, the user device 104 is capable of comprising a desktop computer, a personal data assistant, a cellular-enabled communications device, a wireless-enabled communications device, a web-enabled communications device, or any combination thereof. As shown in FIG. 1, the user device 104 communicates with the computer network via a communications link 106. As will be understood by the skilled artisan, the communications link 106 is representative of any communications channel known in the art and capable of carrying electronic data between two or more electronic devices, such as, for example and without limitation, Ethernet, Bluetooth, WiMax, 802.11a, 802.11b, 802.11g, 802.11(x), infrared, optical, and the like. Preferably, the user device 104 suitably employs client software enabling interaction with one or more document processing devices via the computer network 102. In one embodiment, the user device 104 suitably includes a web browser advantageously adapted to function as an interface with a document processing system comprising one or more document processing devices.

Furthermore, the system 100 also includes one or more document processing devices, illustrated in FIG. 1 as multifunction peripheral devices 108, 110, 112 and 114. It will be appreciated by those skilled in the art that the one or more document processing devices 108-114 are suitably adapted to perform a variety of document processing services, such as, for example and without limitation, scanning, copying, facsimile, printing, scan to storage, scan to email, and the like. Suitable commercially available document processing devices include, but are not limited to, the Toshiba e-Studio Series Controller.

Each of the document processing devices 108, 110, 112, and 114 are communicatively coupled to the computer network 102 via suitable communications links 116, 118, 120, and 122, respectively. Those skilled in the art will appreciate that the communications links 116-122 are any suitable communications channels known in the art capable of establishing a connection between two or more electronic devices, such as, for example and without limitation, Ethernet, Bluetooth, WiMax, 802.11a, 802.11b, 802.11g, 802.11(x), infrared, optical, and the like. The skilled artisan will further appreciate that each of the document processing devices 108-114 are capable of using different communications links to communicate with the computer network 102 and the user device 104. In one embodiment, the document processing devices 108-114 are suitably adapted to received document data from removable storage media, including without limitation, Firewire drives, USB drives, MMC, XD, SD, Compact Flash, Memory Stick, and the like. In the preferred embodiment, document processing jobs are suitably received by the document processing devices 108-114 via the communications links 116-122.

In accordance with the present invention, a user device 104 is suitably adapted to communicate with one or more document processing devices 108-114 via the computer network 102. To facilitate data communication between the user device 104 and the document processing devices 108-114, the user device 104 employs client software suitably adapted to send document processing information to the document processing devices 108-114, as well as to receive document processing information from the document processing devices 108-114. In a preferred embodiment, the client software is an application installed on the user device 104, wherein the application sends job requests to one or more of the document processing devices 108-114 and receives and displays the returned information via an associated user interface. In an alternate embodiment, the client software is replicated via a web browser, i.e., a web-based application, which also enables the user device 104 to exchange job information with the document processing devices 108-114. Those skilled in the art will appreciate that both embodiments are equally capable of employing the methods described below.

In operation, a user submits a job search request to the document processing devices 108-114 via the computer network 102. To state differently, a job search request is transmitted, e.g., broadcast, from the user device 104 to the document processing devices 108-114 using the computer network 102. In one embodiment, the job search request includes a username, corresponding to the user associated with one or more document processing jobs, and features associated with the document processing jobs. For example, certain document processing jobs, such as private, proof, and scheduled jobs are stored in a document processing device's queue until such time as the originating user releases these jobs for output. Each of these jobs, in addition, are capable of including selected features, such as for example and without limitation, color, monochrome, duplex, finishing options, paper size, and the like, which are suitably used to further classify and identify submitted jobs, in addition to the username of the originating user.

Preferably, the search is conducted on all document processing devices 108-114 using any suitable means known in the art, including, without limitation, device discovery via Simple Network Management Protocol (SNMP). It will be appreciated by those skilled in the art that the use of SNMP enables both broadcasting and individual querying, dependent upon the network 102 configuration, as set forth by a system administrator. Each of the document processing devices 108-114 then receive the job search request and perform a search of their respective queues to determine if one or more jobs matching the search parameters are present. When one or more jobs matching the search parameters are present, the jobs are identified via any suitable means and are stored, per device, in a separate job list. This list is returned to the user device 104, whereupon the user is able to select one or more of the returned jobs for release, without having to manually search each queue of each document processing device.

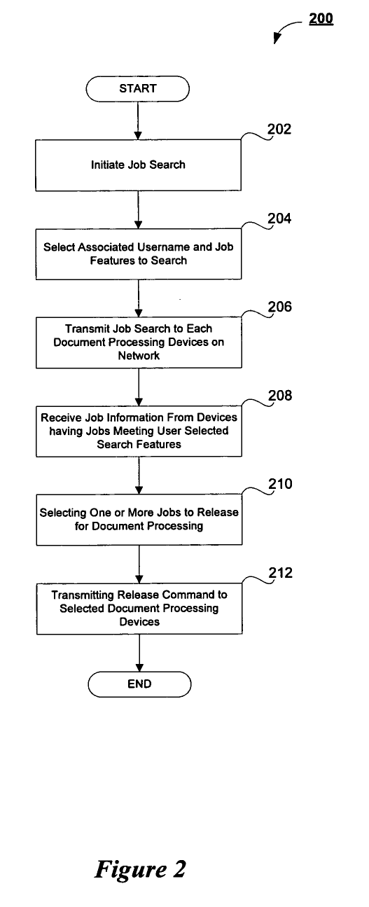

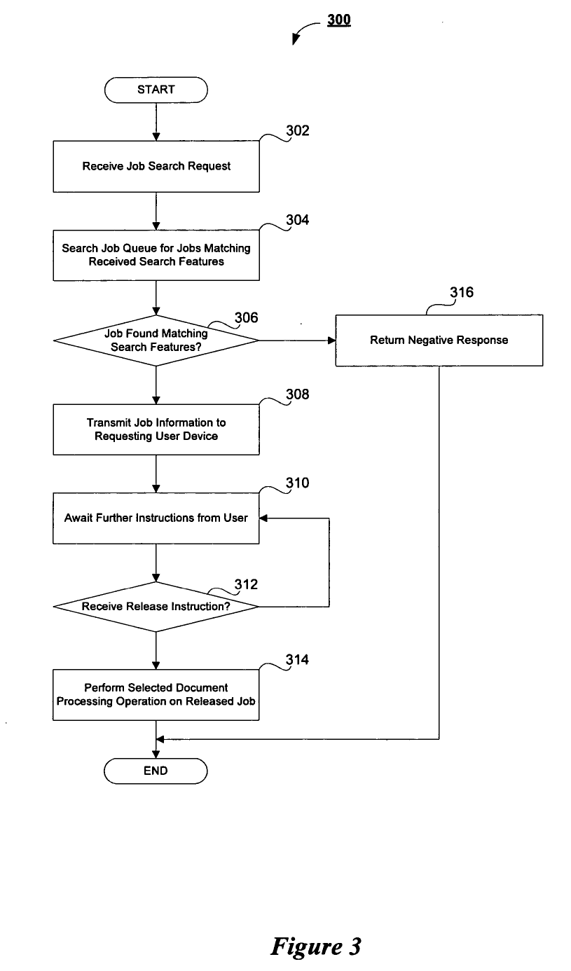

The foregoing description of the system 100 will better be understood when viewed in conjunction with the flowcharts illustrated in FIG. 2 and FIG. 3. Referring now to FIG. 2, there is shown a flowchart 200 illustrating the client side operations in accordance with the present invention. As shown in FIG. 2, the user initiates a job search using the user device 104 at step 202 via any suitable means. It will be understood by those skilled in the art that the initiation of the job search request, as set forth in step 202, is capable of being accomplished via either a client software application or a web-based application. In either event, the method described in FIG. 2 is applicable. At step 204, the user is prompted to select the username associated with the job or jobs, as well as any features corresponding thereto. Preferably, the user selects one or more features associated with a job that the user desires to release. The job search is then transmitted, at step 206, to each document processing device 108-114 on the computer network 102. Those skilled in the art will appreciate that SNMP is capable of being employed by the present invention to facilitate the communication of the search query to the devices 108-114, as well as any other network management protocol known in the art and capable of handling such functions.

The user device 104 then receives job information from the devices 108-114 corresponding to those jobs matching the search criteria submitted by the user at step 208. Preferably, a listing of jobs corresponding to the search request is displayed to the user via any suitable means, enabling the user to view the applicable jobs pending on each of the devices 108-114. The user then selects, from the jobs returned in the job search, one or more pending jobs for release at step 210. It will be understood by those skilled in the art the release of a job indicates that the user is desirous to have the selected job output in accordance with the document processing operation corresponding thereto. In other words, a job is released, for example, from the print queue to the print engine, or alternatively, a job is released to the facsimile engine from the facsimile queue. At step 212, the user transmits a release command to the document processing device or devices containing the job or jobs selected for release. It will be appreciated by those skilled in the art that upon submission of the release command, the job is then output in accordance with the selected document processing operation.

Turning now to FIG. 3, there is shown a flowchart 300 illustrating the document processing side of the method in accordance with the present invention. The skilled artisan will appreciate that the flowchart 300 suitably depicts the method with respect to a single document processing device, however it will be apparent to those skilled in the art that the method described by FIG. 3 is replicated by each document processing device 108-114 present on the computer network 102. Beginning at step 302, a job search request is received by the document processing device 108, via the computer network 102. To facilitate explanation only of the flowchart 300 of FIG. 3, discussion will employ the document processing device 108. Once the job search request has been received, the document processing device 108 performs a search of applicable job queues to locate any pending jobs matching the search features at step 304. At step 306, a determination is made whether a job matching the search features has been located. When no jobs matching the search features have been located, flow proceeds to step 316, wherein a negative response is sent back to the requesting user. In an alternate embodiment, the received search query is ignored the document processing device 108 following a determination that no pending jobs match the features of the search request.

When a job has been located matching the search features received in the job search request at step 306, flow proceeds to step 308, wherein the job information is transmitted to the user device 104. The document processing device 108 then waits at step 310 for further instructions from the user. Those skilled in the art will appreciate that the document processing device 108 waits in accordance with the instructions originally contained in the submitted document processing job. At step 312, a determination is made whether the document processing device 108 has received a release instruction for one or more document processing jobs. When no such release instruction has been received, flow returns to step 310, wherein the document processing device 108 continues to wait a predetermined period of time before checking for a release command. When a release command has been received, flow proceeds to step 314, where the document processing device 108 performs the requested document processing operation on the selected job.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A method for detecting at least one selected document processing job at least one document processing device on a network, the method comprising the steps of:
receiving data representative of at least one selected property associated with at least one document processing job;
transmitting a query to each document processing device on the network whether any document processing jobs having the at least one selected property have been received by the document processing device for processing;
detecting, in response to the query, for each document processing device on the network, all document processing jobs having the at least one selected property; and
selectively communicating the detected document processing jobs for each document processing device so as to be available to an associated user.

2. The method for detecting at least one selected document processing job on at least one document processing device on a network of claim 1 wherein the data is received from an associated user via an associated user interface.

3. The method for detecting at least one selected document processing job on at least one document processing device on a network of claim 1 wherein the query is transmitted to each document processing device on the network via simple network messaging protocol.

4. The method for detecting at least one selected document processing job on at least one document processing device on a network of claim 1 wherein the detected document processing jobs for each document processing device are communicated to an associated storage medium.

5. The method for detecting at least one selected document processing job on at least one document processing device on a network of claim 4 further comprising the step of displaying the detected document processing jobs for each document processing device on an associated display.

6. The method for detecting at least one selected document processing job on at least one document processing device on a network of claim 5 further comprising the steps of:
receiving user selection data from an associated user representative of selection of at least detected one document processing job; and
transmitting the selection data to each of the document processing devices having the selected document processing device commence processing the selected document processing jobs.

7. The method for detecting at least one selected document processing job on at least one document processing device on a network of claim 6 wherein the selection data is transmitted via a simple network messaging protocol.

8. A system for detecting at least one selected document processing job at least one document processing device on a network, the system comprising:
means adapted for receiving data representative of at least one selected property associated with at least one document processing job;
means adapted for transmitting a query to each document processing device on the network whether any document processing jobs having the at least one selected property have been received by the document processing device for processing;
means adapted for detecting, in response to the query, for each document processing device on the network, all document processing jobs having the at least one selected property; and
means adapted for selectively communicating the detected document processing jobs for each document processing device so as to be available to an associated user.

9. The system for detecting at least one selected document processing job on at least one document processing device on a network of claim 8 wherein the data is received from an associated user via an associated user interface.

10. The system for detecting at least one selected document processing job on at least one document processing device on a network of claim 8 wherein the query is transmitted to each document processing device on the network via simple network messaging protocol.

11. The system for detecting at least one selected document processing job on at least one document processing device on a network of claim 8 wherein the detected document processing jobs for each document processing device are communicated to an associated storage medium.

12. The system for detecting at least one selected document processing job on at least one document processing device on a network of claim 11 further comprising means adapted for displaying the detected document processing jobs for each document processing device on an associated display.

13. The system for detecting at least one selected document processing job on at least one document processing device on a network of claim 12 further comprising:
means adapted for receiving user selection data from an associated user representative of selection of at least detected one document processing job; and
means adapted for transmitting the selection data to each of the document processing devices having the selected document processing device commence processing the selected document processing jobs.

14. The system for detecting at least one selected document processing job on at least one document processing device on a network of claim 6 wherein the selection data is transmitted via a simple network messaging protocol.

15. A computer-readable medium having computer-readable instructions stored thereon for detecting at least one selected document processing job at least one document processing device on a network, comprising:
instructions for receiving data representative of at least one selected property associated with at least one document processing job;
instructions for transmitting a query to each document processing device on the network whether any document processing jobs having the at least one selected property have been received by the document processing device for processing;
instructions for detecting, in response to the query, for each document processing device on the network, all document processing jobs having the at least one selected property; and
instructions for selectively communicating the detected document processing jobs for each document processing device so as to be available to an associated user.

16. The computer-readable medium having computer-readable instructions stored thereon for detecting at least one selected document processing job on at least one document processing device on a network of claim 15 wherein the data is received from an associated user via an associated user interface.

17. The computer-readable medium having computer-readable instructions stored thereon for detecting at least one selected document processing job on at least one document processing device on a network of claim 15 wherein the query is transmitted to each document processing device on the network via simple network messaging protocol.

18. The computer-readable medium having computer-readable instructions stored thereon for detecting at least one selected document processing job on at least one document processing device on a network of claim 15 wherein the detected document processing jobs for each document processing device are communicated to an associated storage medium.

19. The computer-readable medium having computer-readable instructions stored thereon for detecting at least one selected document processing job on at least one document processing device on a network of claim 18 further instructions for displaying the detected document processing jobs for each document processing device on an associated display.

20. The computer-readable medium having computer-readable instructions stored thereon for detecting at least one selected document processing job on at least one document processing device on a network of claim 19 further comprising:
instructions for receiving user selection data from an associated user representative of selection of at least detected one document processing job; and
instructions for transmitting the selection data to each of the document processing devices having the selected document processing device commence processing the selected document processing jobs.
